(19) United States
(12) Patent Application Publication
(10) Pub. No.: US 2005/0101182 A1
(43) Pub. Date: May 12, 2005

(54) Supporting device having cable holding portion

(76) Inventors: Hiroshi Nakamura, Ome-shi (JP); Shinichi Kido, Ome-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/985,138

(22) Filed: Nov. 10, 2004

(30) Foreign Application Priority Data
Nov. 12, 2003 (JP) 2003-382715

(51) Int. Cl. H01R 13/60

(52) U.S. Cl. 439/529

(57) ABSTRACT

A supporting device has a first housing, a second housing which removably supports the first housing, and a cable connecting the first housing and the second housing. The second housing has a cable holder which holds the cable when it supports the first housing.

### CROSS-REFERENCE TO RELATED APPLICATIONS

This application is based upon and claims the benefit of priority from prior Japanese Patent Application No. 2003-382715, filed Nov. 12, 2003, the entire contents of which are incorporated herein by reference.

### BACKGROUND OF THE INVENTION

1. Field of the Invention

The present invention relates to a supporting device for use in connecting an electronic apparatus, such as a portable computer, to external equipments.

2. Description of the Related Art

In an electronic apparatus, such as a portable computer, superiority in portability is an important factor of raising the commercial value of the product. Therefore, the housing of the portable computer is designed to be thin and compact. Accordingly, it is impossible to provide sufficient space, inside the housing, for a plurality of connectors to be connected to external equipments, a multi-drive, or the like.

The portable computer, attaching importance to the portability, is mounted with an expansion connector. The expansion connector is used to connect the portable computer to an expansion apparatus called a docking station. The use of the expansion apparatus allows the portable computer to perform the functions equivalent to those of a desktop computer.

A conventional expansion apparatus comprises a tray, which removably supports a portable computer, a cable dock having a plurality of auxiliary connectors to be connected to various external equipments, and an interface cable extending between the tray and the cable dock. The interface cable has connectors at the respective ends. One connector is electrically connected to the tray. The other connector is electrically connected to the cable dock.

Therefore, when the portable computer is placed on the tray, signal paths, such as data buses for transmitting logic addresses and various control signals of the portable computer and the cable dock, are electrically connected to each other via the interface cable. For example, U.S. Pat. No. 6,407,914B1 discloses such an expansion apparatus.

In the expansion apparatus disclosed in the above U.S. patent, the interface cable is exposed to the outside of the tray and the cable dock. Since the interface cable is always bared, the expansion apparatus looks poor.

Moreover, since the wiring route of the interface cable is not fixed, the interface cable may be wound around or caught in a surrounding article, for example, when the expansion apparatus is carried about. This may be a cause of a deformation or break of the interface cable, and the interface cable requires careful handling.

### BRIEF SUMMARY OF THE INVENTION

According to an embodiment of the present invention, there is provided a supporting device comprises a first housing, a second housing which removably supports the first housing, and a cable connecting the first housing and the second housing. The second housing has a cable holding portion which holds the cable when it supports the first housing.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view of a supporting device according to an embodiment of the present invention, which shows a state where a docking tray and a docking base are separated from each other;

FIG. 2 is a perspective view of the supporting device according to the embodiment of the present invention, which shows a state where the docking tray is attached to the docking base;

FIG. 3 is a perspective view of the supporting device according to the embodiment of the present invention, which shows a state where a portable computer is placed on the docking tray attached to the docking base;

FIG. 4 is a sectional view of the docking tray, showing a coupling structure coupling a base and a turntable according to the embodiment of the present invention;

FIG. 5 is a perspective view of the docking tray according to the embodiment of the present invention;

FIG. 6 is a side view of the docking base according to the embodiment of the present invention;

FIG. 7 is a sectional view of the docking base according to the embodiment of the present invention, showing a coupling structure coupling a main body and a tray-supporting portion;

FIG. 8 is a perspective view of the docking base according to the embodiment of the present invention, showing the coupling structure coupling the main body and the tray-supporting portion;

FIG. 9 is a perspective view of the docking base according to the embodiment of the present invention, showing the positional relationship between a projection of the main body and a stopper;

FIG. 10 is a sectional view of a cable and a cable holder according to the embodiment of the present invention; and

FIG. 11 is a sectional view taken along the line A-A in FIG. 6.

### DETAILED DESCRIPTION OF THE INVENTION

An embodiment of the present invention will be described below with reference to the accompanying drawings.

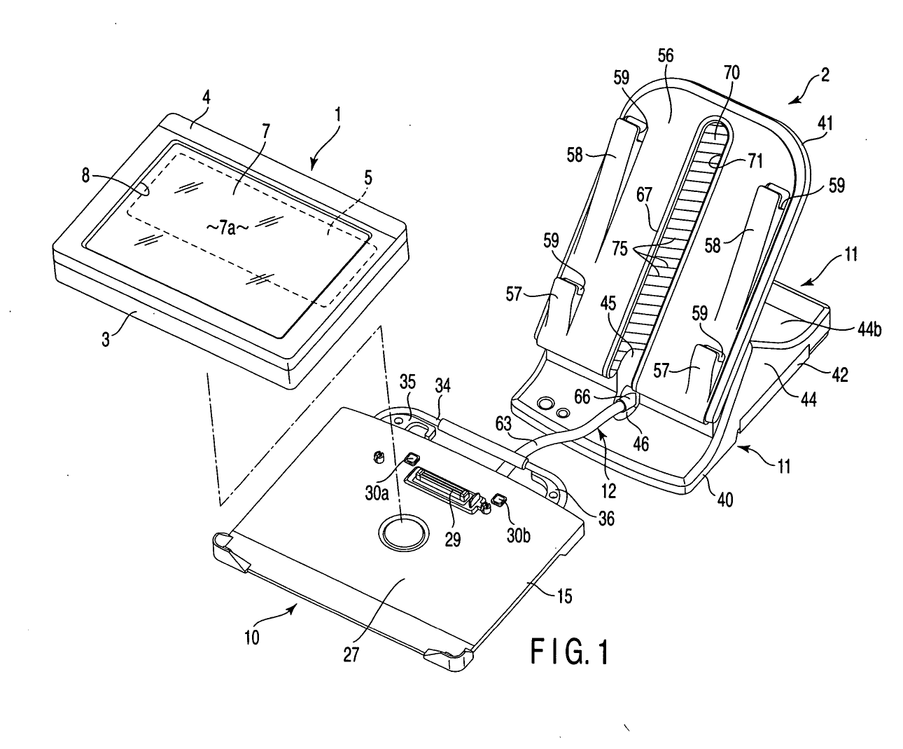

FIG. 1 shows a portable computer 1, as an example of portable electronic apparatuses, and a supporting device 2 for use in expanding the functions of the portable computer 1.

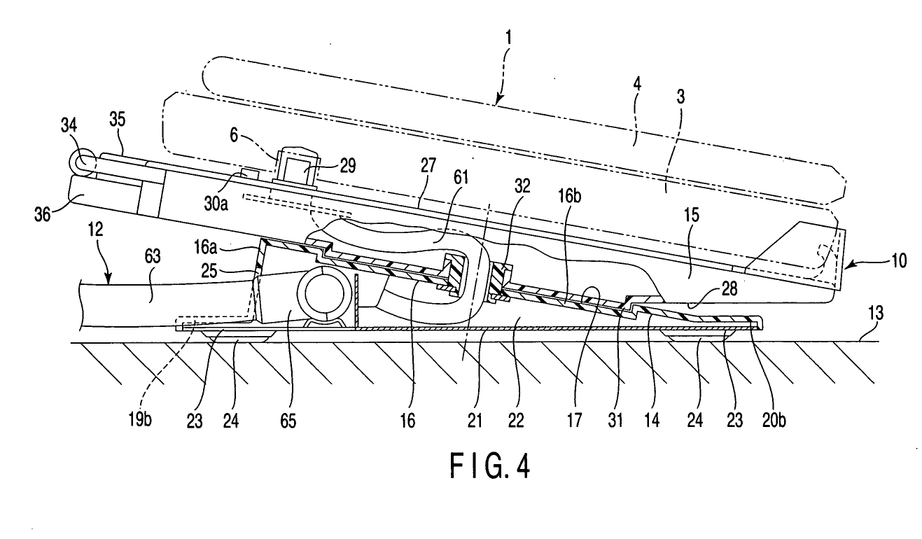

The portable computer 1 comprises a main unit 3 and a display unit 4. The main unit 3 contains primary structural elements, such as a CPU and a hard disk drive, which are not shown. The main unit 3 has a keyboard 5 on the upper surface thereof and an expansion connector 6 as shown in FIG. 4 on the bottom surface thereof.

The display unit 4 contains a tablet 7. The tablet 7 has an input surface 7a to execute an input operation using a tablet pen. The input surface 7a is exposed to the outside of the display unit 4 through an opening 8 formed in the front surface of the display unit 4.

The display unit 4 is coupled to the main unit 3 via a hinge (not shown). The display unit 4 is rotatable between an open position in which it stands so as to expose the keyboard 5 and a closed position in which it flattens to cover the keyboard 5 from above. Further, the display unit 4 is rotatable 180 degrees about the vertical axis in the open position.

When the display unit 4 is rotated 180 degrees in the open position and then rotated to the closed position, it lies over the main unit 3 with the input surface 7a directed upward. In this posture, the portable computer 1 is set to a pen-based input mode.

The supporting device 2 comprises a docking tray 10 as a first housing, a docking base 11 as a second housing and a flexible cable 12.

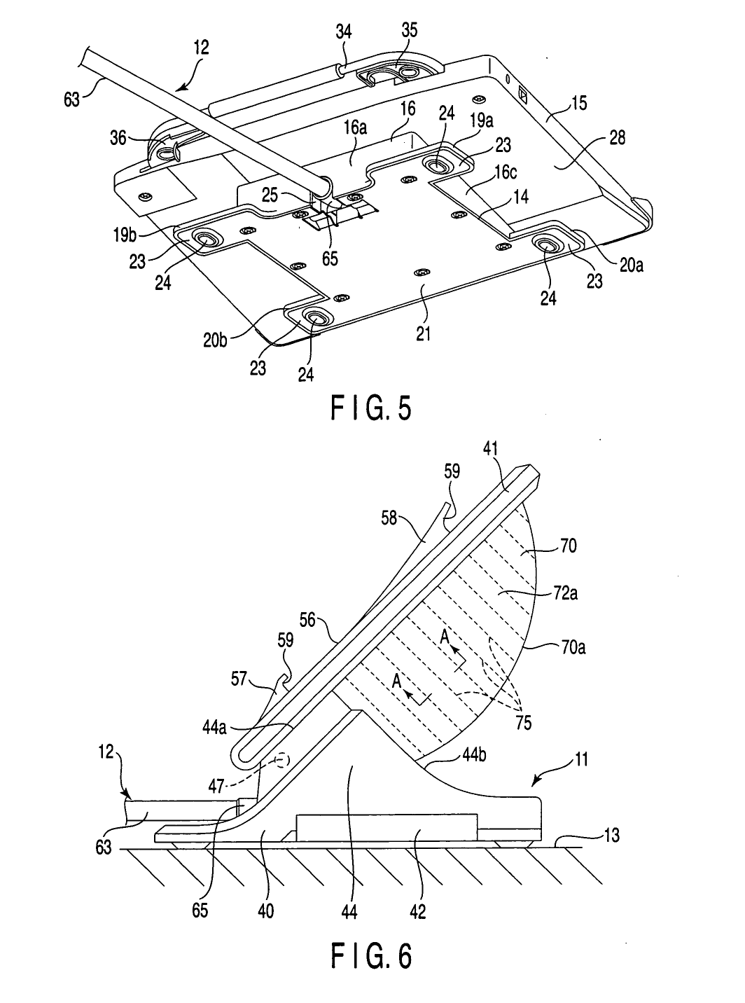

As shown in FIGS. 4 and 5, the docking tray 10 comprises a base 14, which is placed on a horizontal mount surface 13, such as the top of a desk. It also comprises a turntable 15, which removably accepts the portable computer 1.

The base 14 has a table support portion 16 made of synthetic resin. The table support portion 16 is a flat rectangular box, which opens downward and has a back wall 16a, an upper wall 16b, and left and right side walls 16c. The upper wall 16b of the table support portion 16 is inclined down toward the front portion of the docking tray 10. A circular recess portion 17 is formed in a central portion of the upper surface of the upper wall 16b.

As shown in FIG. 5, a pair of first engaging portions 19a and 19b is formed in corner portions defined by the back wall 16a and the left and right side walls 16c of the table support portion 16. The first engaging portions 19a and 19b are shaped as flanges and project sideways from the side walls 16c. A pair of second engaging portions 20a and 20b is formed in front end portions of the table support portion 16. The second engaging portions 20a and 20b are shaped as flanges and project sideways from the side walls 16c. The first and second engaging portions 19a, 19b, 20a and 20b are respectively located at the four corner portions of the table support portion 16.

The lower end of the table support portion 16 is covered by a bottom plate 21 made of metal. The bottom plate 21 has four tongue portions 23. The tongue portions 23 are overlaid respectively with the first and second engaging portions 19a, 19b, 20a and 20b of the table support portion 16. Rubber legs 24, which are to be in contact with the mount surface 13, are respectively formed on the tongue portions 23.

The base 4 has a cable holding chamber 22 in the inside thereof. The cable holding chamber 22 is formed between the bottom plate 21 and the table support portion 16. A first cable exit 25 is formed in a back end portion of the table support portion 16. The first cable exit 25 is situated at a corner portion defined by the back wall 16a and the bottom plate 21, and open to the cable holding chamber 22.

The turntable 15 is a flat rectangular box having a size corresponding to the main unit 3 of the portable computer 1. The turntable 15 has a flat mount surface 27 on which the main unit 3 is removably mounted, and a bottom surface 28 opposing to the mount surface 27. A relay connector 29 and a pair of eject members 30a and 30b is located in a central portion of the mount surface 27. The relay connector 29 is removably connected to the expansion connector 6 of the main unit 3, when the main unit 3 is mounted on the mount surface 27.

The eject members 30a and 30b function to push out the main unit 3 from the mount surface 27. The eject members 30a and 30b are separated from each other in the width direction of the main unit 3. The relay connector 29 is situated between the eject members 30a and 30b. The eject members 30a and 30b are supported by the turntable 15 so as to be movable between a standby position in which they are slightly projected from the mount surface 27 and an eject position in which they are largely projected from the mount surface 27. The eject members 30a and 30b are normally held at the standby position.

When the eject members 30a and 30b are moved from the standby position to the eject position in a state where the main unit 3 is placed on the mount surface 27, the eject members 30a and 30b are caused to push the bottom surface of the main unit 3. Accordingly, the main unit 3 is pushed away from the mount surface 27, so that the connection between the expansion connector 6 and the relay connector 29 is released.

As shown in FIG. 4, a circular projection 31 is formed in a central portion of the bottom surface 28 of the turntable 15. The projection 31 is fitted in the recess portion 17 of the table support portion 16. The projection 31 of the turntable 15 is coupled to the recess portion 17 of the table support portion 16 via a hollow hinge shaft 32. The turntable 15 is rotatable 90 degrees about the hinge shaft 32.

In other words, the turntable 15 is rotatable between a first rotation position and a second rotation position. In the first rotation position, when the portable computer 1 in the pen-based input mode is mounted on the mount surface 27, for example, the input surface 7a of the portable computer 1 is in a landscape configuration. In the second rotation position, when the portable computer 1 in the pen-based input mode is mounted on the mount surface 27, the input surface 7a of the portable computer 1 is in a portrait configuration. The turntable 15 is locked by a lock mechanism (not shown) at each of the first rotation position and the second rotation position.

A handle bar 34 for conveyance is attached to one end portion of the turntable 15. The handle bar 34 is substantially parallel to one side of the turntable 15. An eject lever 35 and a lock release lever 36 are arranged in a region surrounded by the handle bar 34 and the side of the turntable 15. The eject lever 35 is located at one end of the handle bar 34. The lock release lever 36 is located at the other end of the handle bar 34.

The eject lever 35 operates in association with the eject members 30a and 30b on the mount surface 27. The eject members 30a and 30b are moved from the standby position to the eject position by operating the eject lever 35. The lock release lever 36 operates in association with the lock mechanism of the turntable 15. The lock of the turntable 15 is released by operating the lock release lever 36.

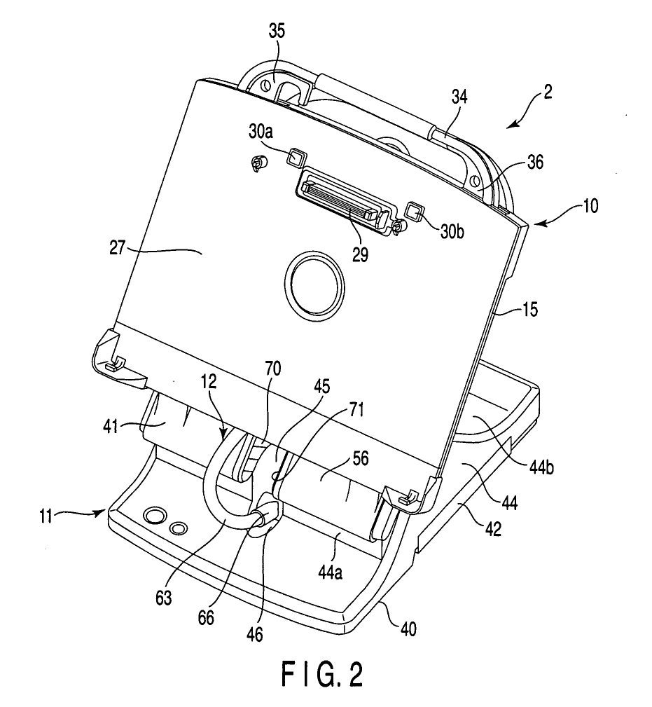

As shown in FIGS. 2, 3 and 6, the docking base 11 comprises a main body 40 to be placed on the mount surface 13, and a tray-supporting portion 41 coupled to the main body 40. The main body 40 contains a multi-drive 42, integrally formed of, for example, a CD-ROM drive and a DVD-ROM drive. Further, the main body 40 is equipped with a plurality of connectors 43, such as PS2, serial, parallel and USB connectors. The connectors 43 are used to connect with peripheral equipments, for example, a floppy disk drive and a printer. They are arranged on the back and side surfaces of the main body 40. Thus, in this embodiment, the multi-drive 42 and the connector 43 constitute a function expansion portion for expanding the functions of the portable computer 1.

The main body 40 comprises a projection 44 projecting upward. The projection 44 has a front surface 44a and a back surface 44b. The front surface 44a is inclined down toward the front end of the main body 40. The back surface 44b is inclined down toward the back end of the main body 40. Thus, the projection 44 tapers off to a point above the main body 40.

A slit 45 is formed on the top of the projection 44. The slit 45 is located in the middle along the width direction of the main body 40, and extends in the depth direction of the main body 40. The slit 45 is opened in the front surface 44a and the back surface 44b of the projection 44.

As shown in FIG. 2, a second cable exit 46 is formed in a central portion of the front surface 44a of the projection 44. The second cable exit 46 is open to the inside of the main body 40 and located at a front end portion of the slit 45.

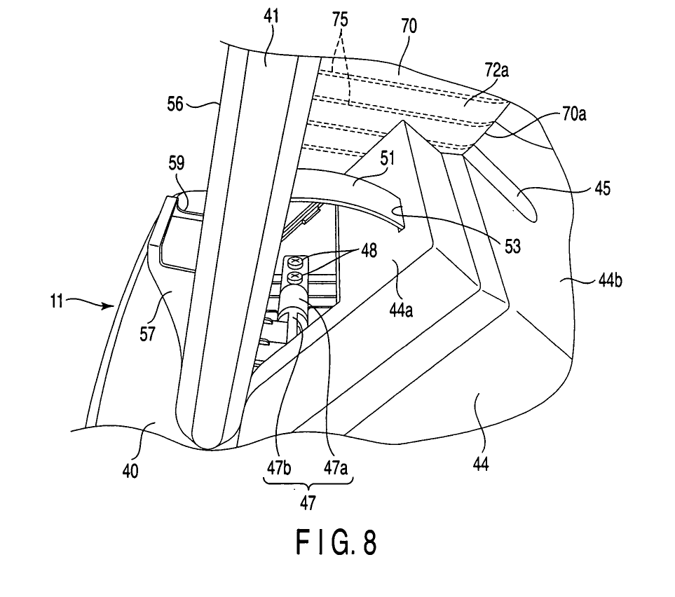

The tray-supporting portion 41 removably supports the docking tray 10 and has a shape of a flat hollow box. The tray-supporting portion 41 stands above the main body 40. As shown in FIGS. 6 to 8, a lower end portion of the tray-supporting portion 41 is coupled to a front end portion of the main body 40 via a pair of hinge shafts 47 (only one of the shafts is shown). The hinge shafts 47 are arranged horizontally and separated from each other in the width direction of the main body 40 with the slit 45 interposed therebetween.

Each hinge shaft 47 has a first shaft portion 47a and a second shaft portion 47b. The first and second shaft portions 47a and 47b are coaxially connected. Braking force, which restricts free rotation of the hinge shaft 47, is applied to the connecting portion. The first shaft portion 47a of the hinge shaft 47 is fixed to the front end portion of the main body 40 by screws 48. The second shaft portion 47b of the hinge shaft 47 is fixed to the lower end portion of the tray-supporting portion 41 by a screw 49.

By means of the above structure, the tray-supporting portion 41 is rotatable between a first inclination position in which it is inclined along the front surface 44a of the projection 44 and a second inclination position in which it is raised away from the front surface 44a of the projection 44. The supporting portion 41 may be held in an arbitrary position between the first and second inclination positions by the hinge shafts 47 of the tray-supporting portion 41.

Thus, when the portable computer 1 in the pen-based input mode is placed on the docking tray 10 attached to the tray-supporting portion 41, the inclination angle of the portable computer 1 can be changed freely, so that the operator can easily and satisfactorily look at the input surface 7a of the portable computer 1.

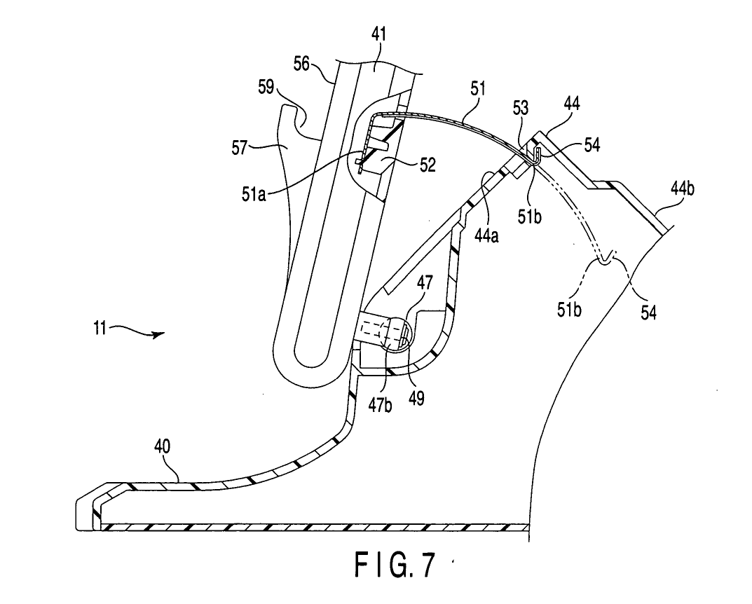

As shown in FIGS. 7 to 9, the tray-supporting portion 41 has a pair of stoppers 51. The stoppers 51 restrict excessive rotation of the tray-supporting portion 41. The stoppers 51 are located at a left end portion and a right end portion of the tray-supporting portion 41, and extend between the tray-supporting portion 41 and the main body 40. Each of the stoppers 51 is formed of a metal band plate and bent to form an arc about the hinge shaft 47 as the center of the circle.

The stopper 51 has a first end 51a and a second end 51b. The first end 51a is introduced in the inside of the tray-supporting portion 41 and fixed to a boss portion 52 projecting from the inner surface of the tray-supporting portion 41. The second end 51b of the stopper 51 is introduced in the inside of the projection 44 through a through hole 53 opened in the front surface 44a of the projection 44.

An engagement portion 54, which is bent upward, is formed at the second end 51b of the stopper 51. The engagement portion 54 is engaged with an open edge of the through hole 53, when the tray-supporting portion 41 reaches the second inclination position. As a result, the rotation of the tray-supporting portion 41 is restricted, so that it is maintained at the second inclination position.

The tray-supporting portion 41 has a front surface 56, which receives the base 14 of the docking tray 10. The front surface 56 is wider than the base 14. A pair of tray receivers 57 and 58 is formed on each of left and right side portions of the front surface 56. The tray receivers 57 and 58 on each side are separated from each other along the height direction of the front surface 56. Each of the tray receivers 57 and 58 is projected from the front surface 56 so as to incline down toward the lower end of the front surface 56. An engaging groove 59, which opens upward, is formed on the upper end of each of the tray receivers 57 and 58.

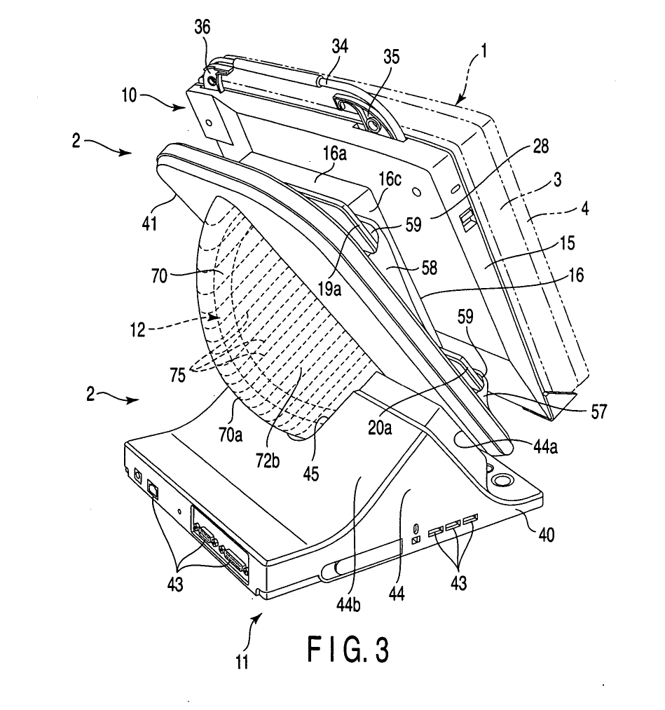

FIGS. 2 and 3 show a state where the docking tray 10 is mounted on the front surface 56 of the tray-supporting portion 41. When the docking tray 10 is slid over the front surface 56 in the direction from top to bottom of the tray-supporting portion 41, it is coupled with the tray-supporting portion 41. More specifically, the table support portion 16 of the base 14 enters the gap between the tray receivers 57 and 58, and the first and second engaging portions 19a, 19b, 20a and 20b at the four corner portions of the base 14 are engaged with the engaging grooves 59 at the top ends of the tray receivers 57 and 58.

As a result, the docking tray 10 is removably supported by the tray-supporting portion 41 by the first and second engaging portions 19a, 19b, 20a and 20b, and the rubber legs 24 at the four corners of the base 14 are in contact with the front surface 56.

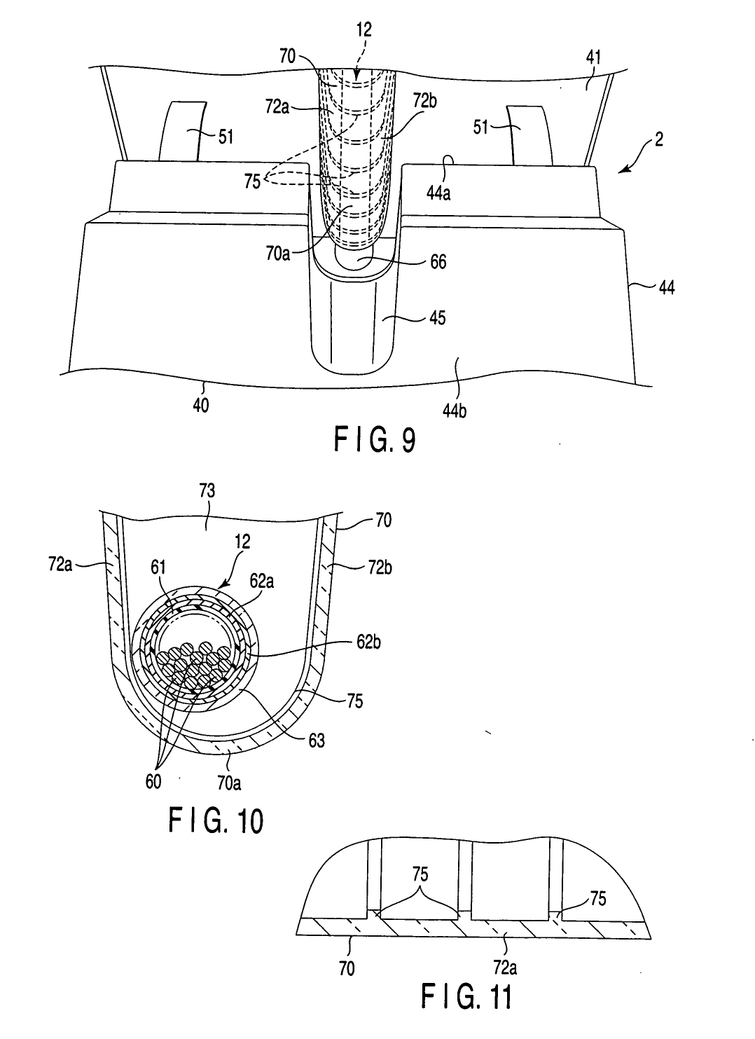

The cable 12 extends between the docking tray 10 and the docking base 11. As shown in FIG. 10, the cable 12 comprises a plurality of signal lines 60, an insulating layer 61, an inner shield layer 62a, an outer shield layer 62b and a protecting tube 63.

The signal lines 60 electrically connect the relay connector 29 of the docking tray 10 and the function expansion portion of the docking base 11. The insulating layer 61 covers the signal lines 60, thereby binding them into one. The inner shield layer 62a and the outer shield layer 62b doubly cover the insulating layer 61 from outside. The protecting tube 63 is made of transparent synthetic resin and covers the outer shield layer 62b. Thus, the cable 12 of this embodiment is about 10 mm thick.

As shown in FIG. 4, one end of the cable 12 is introduced into the cable holding chamber 22 in the base 14 through the first cable exit 25, and further introduced into the turntable 15 through the hollow portion of the hinge shaft 32. The signal lines 60 of the cable 12 are connected to the relay connector 29 of the turntable 15.

A cable guide 65, through which the cable 12 is inserted, is provided at the first cable exit 25. The cable guide 65 guides the cable 12 led out from the first cable exit 25 and is rotatably supported by the table support portion 16 of the docking tray 10.

As shown in FIGS. 1 and 2, the other end of the cable 12 is introduced into the inside of the main body 40 through the second cable exit 46. The signal lines 60 of the cable 12 are connected to the multi-drive 42 and the connectors 43. A cable guide 66, through which the cable 12 is inserted, is provided at the second cable exit 46. The cable guide 66 guides the cable 12 led out from the second cable exit 46, and is rotatably supported by the main body 40 of the docking base 11.

As shown in FIG. 1, a slit-shaped opening 67 is formed in a central portion of the front surface 56 of the tray-supporting portion 41. The opening 67 extends in the height direction of the tray-supporting portion 41. The lower end of the opening 67 is open at the lower end of the tray-supporting portion 41. The second cable exit 46 is located just under the lower end of the opening 67.

A cable holder 70, which serves as a cable holding portion, is attached to the tray-supporting portion 41. The cable holder 70 is made of, for example, transparent polycarbonate resin material, and has a shape of a flat box having a cable introducing port 71 at one end. The cable holder 70 is fitted in the opening 67 of the tray-supporting portion 41. The cable introducing port 71 of the cable holder 70 is opened in the front surface 56 of the tray-supporting portion 41.

As shown in FIGS. 3 and 6, the cable holder 70 has a projection end 70a projected backward from the tray-supporting portion 41. The projection end 70a of the cable holder 70 faces the cable introducing port 71. The projection end 70a is bent like an arc, and is not opened but is closed to the outside of the supporting device 2. The lower end of the projection end 70a enters the slit 45 of the main body 40.

The cable holder 70 has a pair of side walls 72a and 72b connecting between the cable introducing port 71 and the projection end 70a. The side walls 72a and 72b face each other with a distance therebetween. A holding chamber 73, in which the cable 12 is removably inserted, is formed between the side walls 72a and 72b. The holding chamber 73 communicates with the cable introducing port 71.

As shown in FIGS. 10 and 11, a plurality of rib-like projections 75 are formed integrally with the inner surface of the projection end 70a and the inner surfaces 72a and 72b of the cable holder 70. The projections 75 extend from the projection end 70a to the cable introducing port 71, and arrange parallel to one another with a distance therebetween. The projections 75 are exposed in the holding chamber 73 and the top ends thereof can be slidably brought into contact with the protecting tube 63, i.e., the peripheral surface of the cable 12.

The supporting device 2 of the above structure can be used in two modes. In a first mode, as shown in FIG. 1, the docking tray 10 is detached from the docking base 11, and the portable computer 1 is used in the state where it is mounted on the docking tray 10. In a second mode, the docking tray 10 is attached to the docking base 11 and the portable computer 1 is used in the state where it is mounted on the docking tray 10.

When the supporting device 2 is used in the first mode, the docking tray 10, as well as the docking base 11, is placed on the mount surface 13 and nearer to the operator than the docking base 11. Therefore, the cable 12 is led from the front end portion of the docking base 11 to the back end portion of the docking tray 10 on the mount surface 13.

When the docking tray 10 on the mount surface 13 is lifted up and brought nearer to the tray-supporting portion 41 of the docking base 11, the cable 12 is lifted above the mount surface 13. With this movement of the cable 12, the cable guide 66 of the docking base 11 is rotated upward and the cable 12 led out of the second cable exit 46 is introduced to the lower end of the cable introducing port 71.

When the docking tray 10 is moved to a position where it faces the front surface 56 of the tray-supporting portion 41, the cable 12 is inserted into the holding chamber 73 of the cable holder 70 sequentially from the lower end of the cable introducing port 71. In this time, the first cable exit 25 of the docking tray 10 faces the upper end portion of the cable introducing port 71, with the result that the cable 12 led out of the exit 25 is pulled downward. Therefore, the cable guide 65 located at the first cable exit 25 is rotated downward and the cable 12 led from the exit 25 is inserted into the holding chamber 73 of the cable holder 70 sequentially from the upper end of the cable introducing port 71.

In the second mode, in which the docking tray 10 is mounted on the front surface 56 of the tray-supporting portion 41, the first and second engaging portions 19a, 19b, 20a and 20b at the four corners of the base 14 are engaged with the engaging grooves 59 of the tray receivers 57 and 58. With this engagement, the cable 12 led from the first cable exit 25 of the docking tray 10 is guided into the holding chamber 73 of the cable holder 70 from the upper end portion of the cable introducing port 71. In this time, the cable 12 led from the second cable exit 46 of the docking base 11 is inserted into the holding chamber 73 of the cable holder 70 from the lower end portion of the cable introducing port 71.

As a result, the cable 12 extending between the docking tray 10 and the docking base 11 is held inside the holding chamber 73 of the cable holder 70, so that it is curved like an arc along the projection end 70a of the cable holder 70.

According to the embodiment described above, in the second mode, in which the docking tray 10 is mounted on the tray-supporting portion 41 of the docking base 11, the cable 12 extending between the docking tray 10 and the docking base 11 is held inside the holding chamber 73 of the cable holder 70. Thus, the cable 12 is not bared and the supporting device 2 looks neat.

Further, the cable 12 is protected by the cable holder 70 and kept in a fixed position and posture. Therefore, even if the supporting device 2 is moved, the cable 12 will not be wound around or caught in a surrounding article. Thus, the cable 12 is prevented from deformation or damage.

In addition, since the cable holder 70 is made of transparent synthetic resin, the cable 12 can be seen through the projection end 70a, the side walls 72a and 72b of the cable holder 70. Therefore, the process of movement of the cable 12 being inserted into the holding chamber 73 within the cable holder 70 can be observed from outside. Hence, the cable 12 can be prevented from, for example, being twisted or bent when inserted in the holding chamber 73.

Since the protecting tube 63 of the cable 12 and the cable holder 70 are both made of synthetic resin, if the protecting tube 63 is brought into close contact with the inner surface of the cable holder 70, the former may be stuck fast to the latter. In this case, when the cable 12 is being inserted into the cable holder 70, great sliding resistance is generated in a contact portion between the cable 12 and the cable holder 70, with the result that the cable 12 cannot easily move in the cable holder 70.

In the above embodiment, the projections 75 extending from the projection end 70a to the cable introducing port 71 are formed on the inner surface of the cable holder 70, facing the holding chamber 73. Therefore, the protecting tube 63 of the cable 12 is brought into contact with only the top ends of the projections 75, when it is introduced into or drawn out of the cable holder 70. In other words, the protecting tube 63 of the cable 12 is partially in non-contact with the inner surfaces of the side walls 72a and 72b.

As a result, the protecting tube 63 is prevented from being in close contact with the inner surfaces of the side walls 72a and 72b continuously along the axial direction of the tube. In other words, the projections 75 serve as a guide rail to improve slip of the protecting tube 63. Therefore, the protecting tube 63 easily slips along the side walls 72a and 72b and the cable 12 moves smoothly in the cable holder 70. Accordingly, the cable 12 can be easily inserted in and drawn out of the cable holder 70.

In the above embodiment, the cable holder is made of transparent synthetic resin. However, the present invention is not limited to this embodiment; for example, the cable holder may be formed of metal.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A supporting device comprising:
a first housing;
a second housing which removably supports the first housing; and
a cable connecting the first housing and the second housing,
wherein the second housing has a cable holding portion which holds the cable when it supports the first housing.

2. The supporting device according to claim 1, wherein the first housing has a table which removably supports an electronic apparatus, and a connector which is provided on the table and to which the electronic apparatus is removably connected.

3. The supporting device according to claim 2, wherein the second housing has a main body and a support portion which receives the first housing, the support portion being allowed to stand relative to the main body at an adjustable angle.

4. The supporting device according to claim 3, wherein the main body has a function expansion portion which expands functions of the electronic apparatus.

5. The supporting device according to claim 4, wherein the cable electrically connects the connector and the function expansion portion, and is drawn out of the first and second housings.

6. The supporting device according to claim 3, wherein the cable holding portion is transparent and has a cable introduction port which is opened in the support portion.

7. A supporting device comprising:
a tray which removably supports an electronic apparatus;
a base having a main body and a tray-supporting portion which is provided on the main body and which removably supports the tray; and
a cable electrically connecting the tray and the base, the cable being drawn out of the, tray and the base,
wherein the tray-supporting portion of the base has a cable holding portion which holds the cable when it supports the tray.

8. The supporting device according to claim 7, wherein the tray-supporting portion has a front surface which stands relative to the main body and receives the tray, and the cable holding portion has a cable introducing port which is opened in the front surface of the tray supporting portion.

9. The supporting device according to claim 8, wherein the tray-supporting portion has, on the front surface, a plurality of tray receivers, with which the tray is removably engaged, the tray receivers being separated from each other in the width direction of the front surface.

10. The supporting device according to claim 8, wherein the cable holding portion has a projection end projecting through the tray-supporting portion to a side opposite to the front surface, the projection end facing the cable introducing port and being closed.

11. The supporting device according to claim 10, wherein the cable holding portion has a pair of side walls connecting between the cable introducing port and the projection end, and the cable is removably inserted between the side walls of the cable holding portion.

12. The supporting device according to claim 11, wherein the side walls of the cable holding portion have, on inner surfaces thereof, a plurality of projections with which a peripheral surface of the cable is slidably brought into contact, the projections extending from the projection end of the cable holding portion to the cable introducing port and being arranged at intervals.

13. The supporting device according to claim 7, wherein the cable has a plurality of signal lines and a protecting tube made of synthetic resin and covering the signal lines, and the cable holding portion is made of transparent synthetic resin.

14. The supporting device according to claim 7, wherein the tray has a connector, to which the electronic apparatus is electrically connected, the main body of the base has a function expansion portion which expands functions of the electronic apparatus, and the cable electrically connects the connector and the function expansion portion.
